(19) United States
(12) Patent Application Publication
(10) Pub. No.: US 2014/0245909 A1
(43) Pub. Date: Sep. 4, 2014

(54) MULTI-STATION FLEXOGRAPHIC PRINTING PROCESS AND SYSTEM

(71) Applicants: Ed S. Ramakrishnan, Spring, TX (US); Robert J. Petcavich, The Woodlands, TX (US); Daniel Van Ostrand, Conroe, TX (US)

(72) Inventors: Ed S. Ramakrishnan, Spring, TX (US); Robert J. Petcavich, The Woodlands, TX (US); Daniel Van Ostrand, Conroe, TX (US)

(73) Assignee: Uni-Pixel Displays, Inc., The Woodlands, TX (US)

(21) Appl. No.: 13/784,795

(22) Filed: Mar. 4, 2013

(51) Int. Cl. B41F 5/24

(52) U.S. Cl. CPC B41F 5/24
USPC 101/23; 101/492

(57) ABSTRACT

A multi-station flexographic printing method includes transferring an ink from a first flexo master to a substrate. The first flexo master includes an embossing pattern. The embossing pattern includes lines of a first width or orientation. Ink is transferred from a second flexo master to the substrate. The second flexo master includes an embossing pattern. The embossing pattern includes lines of a second width or orientation. Ink is transferred from a third flexo master to the substrate. The third flexo master includes an embossing pattern. The embossing pattern includes lines of a third width or orientation. Ink is transferred from a fourth flexo master to the substrate. The fourth flexo master includes an embossing pattern. The embossing pattern includes lines of a fourth width or orientation.

### BACKGROUND OF THE INVENTION

An electronic device with a touch screen allows a user to control the device by touch. The user may interact directly with the objects depicted on the display through touch or gestures. Touch screens are commonly found in consumer, commercial, and industrial devices including smartphones, tablets, laptop computers, desktop computers, monitors, gaming consoles, and televisions. A touch screen includes a touch sensor that includes a pattern of conductive lines disposed on a substrate.

Flexographic printing is a rotary relief printing process that transfers an image to a substrate. A flexographic printing process may be adapted for use in the fabrication of touch sensors. In addition, a flexographic printing process may be adapted for use in the fabrication of flexible and printed electronics (“FPE”).

### BRIEF SUMMARY OF THE INVENTION

According to one aspect of one or more embodiments of the present invention, a multi-station flexographic printing method includes transferring an ink from a first flexo master to a substrate. The first flexo master includes an embossing pattern. The embossing pattern includes lines of a first width or orientation. Ink is transferred from a second flexo master to the substrate. The second flexo master includes an embossing pattern. The embossing pattern includes lines of a second width or orientation. Ink is transferred from a third flexo master to the substrate. The third flexo master includes an embossing pattern. The embossing pattern includes lines of a third width or orientation. Ink is transferred from a fourth flexo master to the substrate. The fourth flexo master includes an embossing pattern. The embossing pattern includes lines of a fourth width or orientation.

According to one aspect of one or more embodiments of the present invention, a multi-station flexographic printing method includes transferring an ink from a plurality of flexo masters to a substrate in sequence. Each flexo master includes an embossing pattern having a different width or orientation.

According to one aspect of one or more embodiments of the present invention, a multi-station flexographic printing system includes a plurality of flexographic printing stations. Each flexographic printing station includes an ink roll, an anilox roll, a plate cylinder, a flexo master disposed on the plate cylinder, and an impression cylinder. Each flexo master of the plurality of flexographic printing stations includes an embossing pattern having a different width or orientation.

Other aspects of the present invention will be apparent from the following description and claims.

### BRIEF DESCRIPTION OF THE DRAWINGS

FIG. 1 shows a flexographic printing station in accordance with one or more embodiments of the present invention.

FIG. 2 shows a portion of a printed pattern design on substrate having junctions between features of different sizes in accordance with one or more embodiments of the present invention.

FIG. 3 shows a cross-sectional view of a conventional flexo master with lines or features of different widths and heights.

FIG. 4 shows a portion of a multi-station flexographic printing system in accordance with one or more embodiments of the present invention.

FIG. 5 shows a multi-station flexographic printing process in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

A conventional flexographic printing system uses a single flexo master that includes embossing patterns that transfer an image to a substrate. In some instances, the embossing patterns include patterned lines or features of different widths. When the patterned lines or features have different widths, the patterned lines or features of the embossing patterns also have different heights. These height differentials may be a consequence of fabricating the flexo master with patterned lines or features with different widths. The height differentials give rise to a number of issues including non-uniform line widths and discontinuities of the printed patterned lines or printed features on the substrate. In addition, because a conventional flexographic printing system uses a single flexo master, all patterned lines and features are subject to the same process parameters including speed, composition, viscosity, pressure, or volume of ink.

In one or more embodiments of the present invention, a multi-station flexographic printing process and system allows for printing different line widths on a single substrate in a uniform manner.

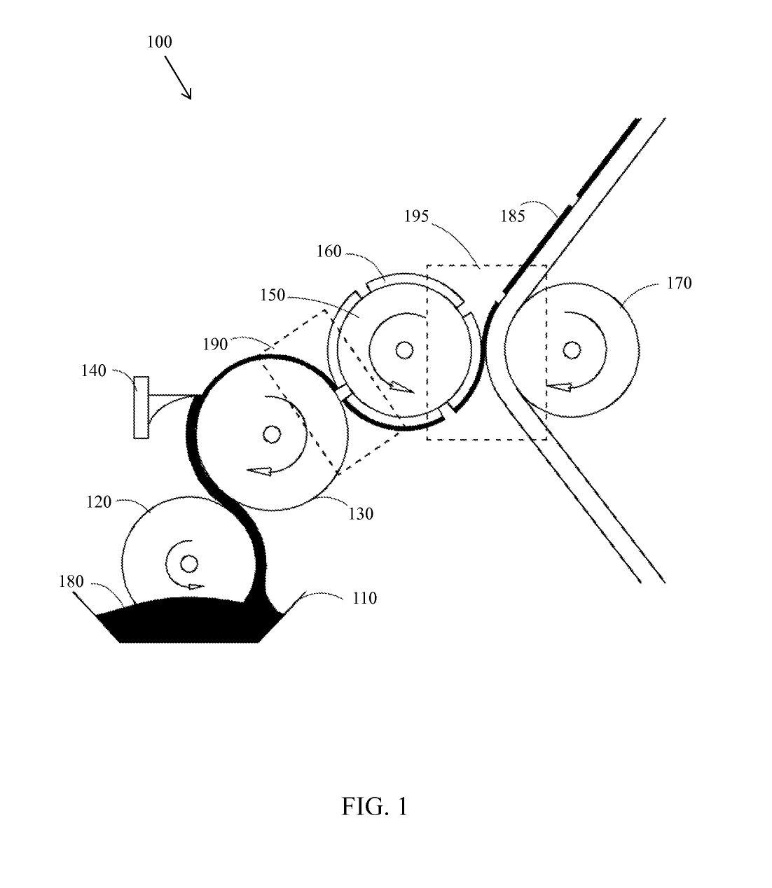

FIG. 1 shows a flexographic printing station 100 in accordance with one or more embodiments of the present invention. Flexographic printing station 100 may include an ink pan 110, an ink roll 120 (also referred to as a fountain roll), an anilox roll 130 (also referred to as a meter roll), a doctor blade 140, a printing plate cylinder 150, a flexo master 160, and an impression cylinder 170. Ink roll 120 transfers ink 180 from ink pan 110 to anilox roll 130.

In one or more embodiments of the present invention, ink 180 may be comprised of an acrylic monomer or polymer element with a concentration by weight of 20% to 99% obtained from commercial providers such as Sartomer or Double Bond, a photo-initiator or thermo-initiator element with a concentration by weight of 1% to 10% obtained from commercial providers such as Ciba Geigy, and an acetate element with a concentration by weight of 0.1% to 15%. In one or more embodiments of the present invention, ink 180 includes an acetate element with a concentration by weight of 3% to 5%. In one or more embodiments of the present invention ink 180 may be UV curable. One of ordinary skill in the art will recognize that ink 180 may vary in accordance with one or more embodiments of the present invention.

Anilox roll 130 is typically constructed of a steel or aluminum core that may be coated by an industrial ceramic whose surface contains a plurality of very fine dimples, known as cells (not shown). Doctor blade 140 removes excess ink 180 from anilox roll 130. In transfer area 190, anilox roll 130 meters the amount of ink 180 transferred to printing plate cylinder 150 to a uniform thickness. Printing plate cylinder 150 may be generally made of metal and the surface may be plated with chromium, or the like, to provide increased abrasion resistance. Flexo master 160 may cover printing plate 150. In one or more embodiments of the present invention, flexo master 160 may be composed of a rubber or photo-polymer. A substrate 185 moves between the printing plate cylinder 150 and impression cylinder 170.

In one or more embodiments of the present invention, substrate 185 may be rigid. In one or more embodiments of the present invention, substrate 185 may be flexible. In one or more embodiments of the present invention, substrate 185 may be opaque. In one or more embodiments of the present invention, substrate 185 may be transparent. In one or more embodiments of the present invention, transparent means the transmission of light with a transmittance rate of 90% or more. In one or more embodiments of the present invention, substrate 185 may be polyethylene terephthalate (“PET”). In one or more embodiments of the present invention, substrate 185 may be polyethylene naphthalate (“PEN”). In one or more embodiments of the present invention, substrate 185 may be cellulose acetate (“TAC”). In one or more embodiments of the present invention, substrate 185 may be linear low-density polyethylene (“LLDPE”). In one or more embodiments of the present invention, substrate 185 may be bi-axially-oriented polypropylene (“BOPP”). In one or more embodiments of the present invention, substrate 185 may be a polyester substrate. In one or more embodiments of the present invention, substrate 185 may be a thin glass substrate. In one or more embodiments of the present invention, substrate 185 may be a polypropylene, foam, paper, aluminum, or foil. One of ordinary skill in the art will recognize that other substrates are within the scope of one or more embodiments of the present invention.

Impression cylinder 170 applies pressure to printing plate cylinder 150, transferring an image onto substrate 185 at transfer area 195. The rotational speed of printing plate cylinder 150 is synchronized to match the speed at which substrate 185 moves through the flexographic printing station 100. The speed may vary between 20 feet per minute to 2000 feet per minute.

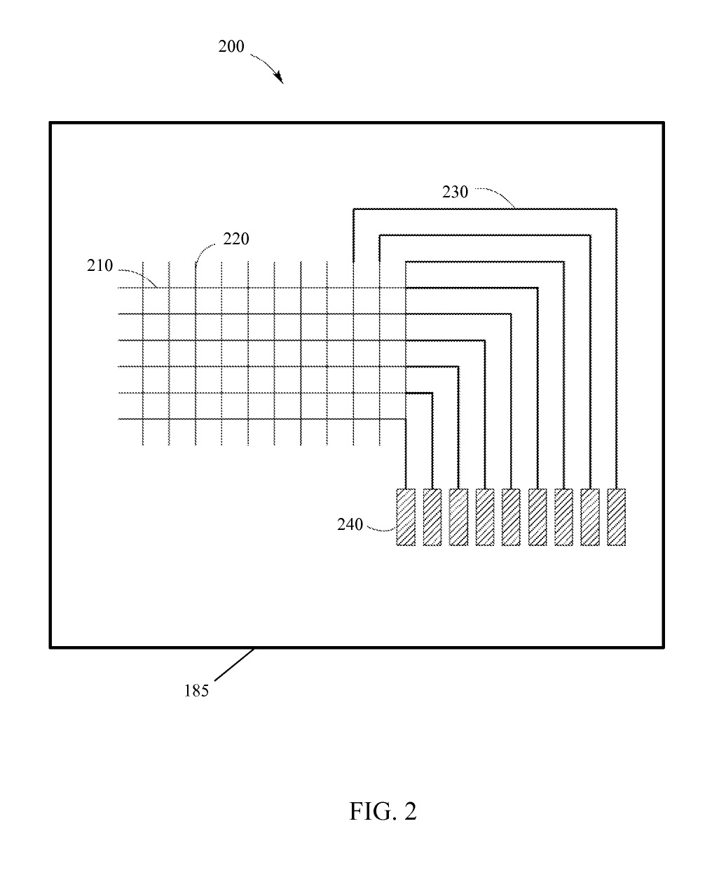

FIG. 2 shows a portion of a printed pattern design 200 on substrate having junctions between features of different sizes in accordance with one or more embodiments of the present invention. In one or more embodiments of the present invention, printed pattern design 200 may comprise a touch sensor. In one or more embodiments of the present invention, printed pattern design 200 includes x-axis printed lines 210 and y-axis printed lines 220 connected by interconnects 230 to connectors 240 on substrate 185. In one or more embodiments of the present invention interconnects 230 may be used to route x-axis printed lines 210 and y-axis printed lines 220 to connectors 240. In one or more embodiments of the present invention, connectors 240 may be configured to provide a connection to an interface. In one or more embodiments of the present invention, one or more of x-axis printed lines 210, y-axis printed lines 220, interconnects 230, and connectors 240 may have different line widths. In one or more embodiments of the present invention, one or more of x-axis printed lines 210, y-axis printed lines 220, interconnects 230, and connectors 240 may have different orientations.

In one or more embodiments of the present invention, x-axis printed lines 210 and y-axis printed lines 220 may have line widths less than 10 microns. In one or more embodiments of the present invention, x-axis printed lines 210 and y-axis printed lines 220 may have line widths in a range between approximately 10 microns and approximately 50 microns. In one or more embodiments of the present invention, x-axis printed lines 210 and y-axis printed lines 220 may have line widths greater than 50 microns. In one or more embodiments of the present invention, x-axis printed lines 210 and y-axis printed lines 220 may have the same width. In one or more embodiments of the present invention, interconnects 230 may have line widths in a range between approximately 50 microns to approximately 100 microns. In one or more embodiments of the present invention, connectors 240 may have line widths greater than 100 microns. One of ordinary skill in the art will recognize that the shape of interconnects 230 may vary in accordance with one or more embodiments of the present invention. One of ordinary skill in the art will recognize that the shape of connectors 240 may vary in accordance with one or more embodiments of the present invention. One of ordinary skill in the art will recognize that printed pattern design 200 may vary in accordance with one or more embodiments of the present invention.

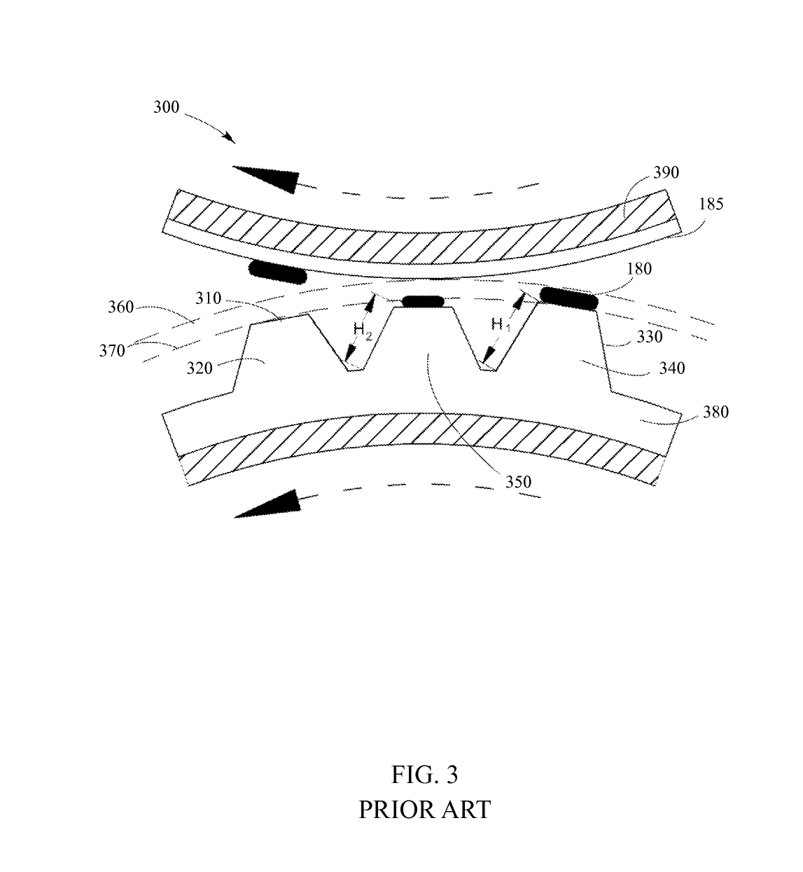

FIG. 3 shows a cross-sectional view 300 of a conventional flexo master with lines or features of different widths and heights. Flexo master 380 includes raised printing surfaces 310 of patterned lines 320 that exhibit angled sidewalls 330. Ink 180 may be transferred from the raised printing surfaces 310 to substrate 185 when impression cylinder 390 presses substrate 185 against raised printing surfaces 310 while flexo master 380 and impression cylinder 390 rotate.

Because patterned lines 320 exhibit different widths or features, they may exhibit different heights. The height differential of patterned lines 320 may be an inherent feature of flexo master 380 when patterned lines 320 have different widths or features. For example, patterned lines 340 may exhibit a height H₁, whereas patterned lines 350 may exhibit a different height H₂. Tall patterned lines 340 may pick up more ink 180 from anilox roll (not shown) and rotate along tall feature arc 360, which may exert more compression when transferring ink 180 to substrate 185. Conversely, short patterned lines 350 may pick up less ink 180 from the anilox roll and rotate along small feature arc 370, which may exert less compression when transferring ink 180 to substrate 185. As a result, the height of patterned lines 320 impacts the amount of ink 180 transferred to substrate 185. Other factors may contribute to the height differential of patterned lines 320 including a mass differential under a given point of patterned lines 320. When patterned lines 320 swell from absorption of moisture, tall patterned lines 340 may swell more than short patterned lines 350 because of their higher density. As a result, printed patterned lines on substrate 185 may exhibit significant line width variations that negatively affect printing performance. In addition, because a single flexo master 380 is used to print patterned lines with different widths or features, the same target speed, composition, viscosity, pressure, and volume of ink must be used.

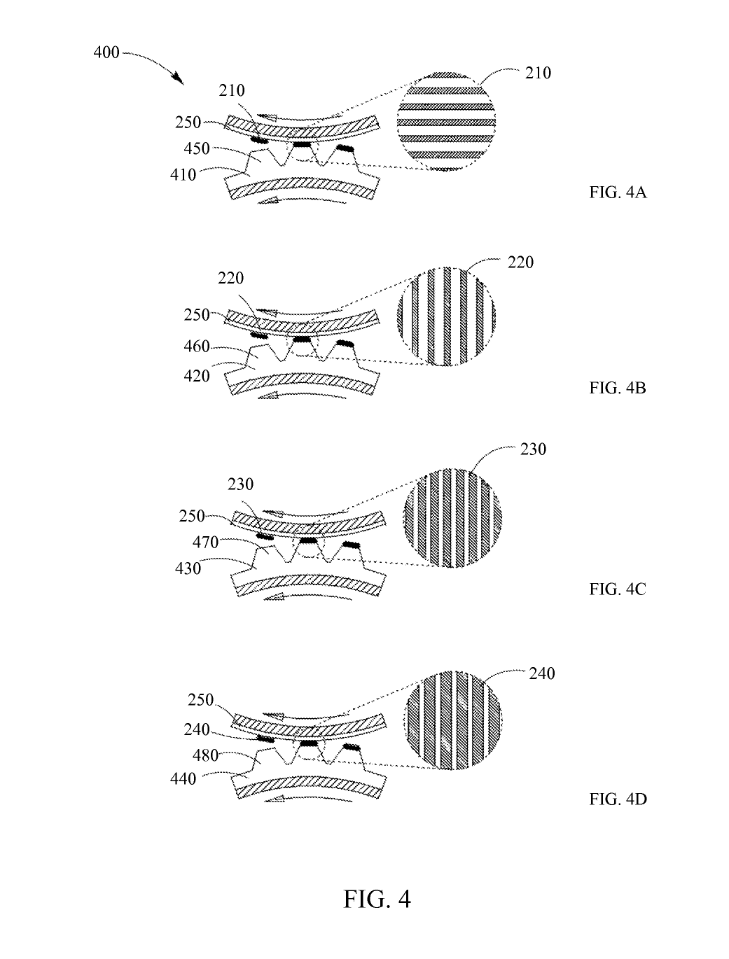

FIG. 4 shows a portion of a multi-station flexographic printing system 400 in accordance with one or more embodiments of the present invention. In one or more embodiments of the present invention, multi-station flexographic printing system 400 includes a plurality of flexographic printing stations that each include an independent flexo master. In one or more embodiments of the present invention, multi-station flexographic printing system 400 comprises a flexographic printing station that includes flexo master 410 configured for printing in an x-axis direction, a flexographic printing station that includes flexo master 420 configured for printing in a y-axis direction, a flexographic printing station that includes flexo master 430 configured for printing interconnect patterns, and a flexographic printing station that includes flexo master 440 configured for printing connector patterns. One of ordinary skill in the art will recognize that the number of flexographic printing stations of a multi-station flexographic printing system may vary in accordance with one or more embodiments of the present invention. One of ordinary skill in the art will recognize that a multi-station flexographic printing system may include a flexographic printing station that includes an independent flexo master for each desired line width, feature, or orientation to minimize line width variations.

FIG. 4A shows a portion of a first flexographic printing station of a multi-station flexographic printing system. A first flexo master 410 comprises an embossing pattern. The embossing pattern comprises patterned lines 450 configured for printing lines 210 in an x-axis direction on substrate 250. In one or more embodiments of the present invention, because each of patterned lines 450 of flexo master 410 are the same width, patterned lines 450 may have the same height. One of ordinary skill in the art will recognize that the first flexographic printing station may include other flexographic printing components in accordance with one or more embodiments of the present invention.

FIG. 4B shows a portion of a second flexographic printing station of a multi-station flexographic printing system. A second flexo master 420 comprises an embossing pattern. The embossing pattern comprises patterned lines 460 configured for printing lines 220 in a y-axis direction on substrate 250. In one or more embodiments of the present invention, because each of patterned lines 460 of flexo master 420 are the same width, patterned lines 460 may have the same height. One of ordinary skill in the art will recognize that the second flexographic printing station may include other flexographic printing components in accordance with one or more embodiments of the present invention.

FIG. 4C shows a portion of a third flexographic printing station of a multi-station flexographic printing system. A third flexo master 430 comprises an embossing pattern. The embossing pattern comprises patterned lines 470 configured for printing interconnect patterns 230 on substrate 250. In one or more embodiments of the present invention, because each of patterned lines 470 of flexo master 430 are the same width, patterned lines 470 may have the same height. One of ordinary skill in the art will recognize that the third flexographic printing station may include other flexographic printing components in accordance with one or more embodiments of the present invention.

FIG. 4D shows a portion of a fourth flexographic printing station of a multi-station flexographic printing system. A fourth flexo master 440 comprises an embossing pattern. The embossing pattern comprises patterned lines 480 configured for printing connector patterns 240 on substrate 250. In one or more embodiments of the present invention, because each of patterned lines 480 of flexo master 440 are the same width, patterned lines 480 may have the same height. One of ordinary skill in the art will recognize that the fourth flexographic printing station may include other flexographic printing components in accordance with one or more embodiments of the present invention.

In one or more embodiments of the present invention, the width of patterned lines 450, patterned lines 460, patterned lines 470, and patterned lines 480 may be different. In one or more embodiments of the present invention, the height of patterned lines 450, patterned lines 460, patterned lines 470, and patterned lines 480 may be the same. In one or more embodiments of the present invention, the orientation of patterned lines 450, patterned lines 460, patterned lines 470, and patterned lines 480 may be different. Because the height differential between patterned lines 450, patterned lines 460, patterned lines 470, and patterned lines 480 is minimized, ink 180 may be more uniformly transferred from the anilox roll to patterned lines 450, patterned lines 460, patterned lines 470, and patterned lines 480 resulting in uniform printing of the printed patterns on substrate 250.

In one or more embodiments of the present invention, the flexographic printing stations of a multi-station flexographic printing system may be sequenced. In one or more embodiments of the present invention, the flexographic printing stations of a multi-station flexographic printing system may be sequenced to print small lines or features before larger lines or features. In one or more embodiments of the present invention, the flexographic printing stations of a multi-station flexographic printing system may be sequenced to print lines or features of different orientations in a desired order. When wide connectors 240 are printed on substrate 250 before printed lines 210 in an x-axis direction or printed lines 220 in a y-axis direction, there may be breaks or discontinuities at their intersection points. In one or more embodiments of the present invention, the flexographic printing stations may be sequenced such that printed lines 210 in an x-axis direction and printed lines 220 in y-axis direction are printed first followed by interconnect patterns 230 and then connector patterns 240.

In one or more embodiments of the present invention, having independent flexo masters for each type of printed pattern allows for more efficient control of printing factors according to specific requirements of each printed pattern. For example, printed lines 210 in an x-axis direction may require a higher concentration of a plating catalyst in the ink compared to wider printed connector patterns 240. As a result, the flexographic printing station with flexo master 410 may use a higher concentration of plating catalyst compared to the flexographic printing station with flexo master 440.

In one or more embodiments of the present invention, each flexographic printing station of a multi-station flexographic printing system may include a UV curing module (not shown). The UV curing module may include a UV light source that initiates the polymerization of acrylic groups within the ink composition in the printed patterns. The UV curing module may include a UV light source that activates the plating catalyst within the ink composition in the printed patterns. In one or more embodiments of the present invention, the ink composition may include metal nanoparticles that may not require a plating catalyst or UV activation.

In one or more embodiments of the present invention, each flexographic printing station of a multi-station flexographic printing system may include an electroless plating bath (not shown). The electroless plating bath may deposit a layer of conductive material on one or more of printed lines 210, printed lines 220, printed interconnects 230, and printed connectors 240 on substrate 250. In one or more embodiments of the present invention, a different type of conductive material may be used for one or more of printed lines 210 in an x-axis direction, printed lines 220 in a y-axis direction, interconnect patterns 230, and connectors 240. In one or more embodiments of the present invention, the electroless plating bath may include copper or other conductive material in a liquid state at temperature range between 20 degrees Celsius and 90 degrees Celsius. One or ordinary skill in the art will recognize that different conductive materials may be used in accordance with one or more embodiments of the present invention. One of ordinary skill in the art will recognize that the electroless plating bath may be varied in accordance with one or more embodiments of the present invention.

In one or more embodiments of the present invention, a different ink composition may be used for each flexo master. In one or more embodiments of the present invention, the ink compositions for each flexo master may be varied to achieve a desired fabrication of the substrate. In one or more embodiments of the present invention, each of the process parameters including target speed, composition, viscosity, pressure, and volume of ink may be varied for each flexo master station. target speed, composition, viscosity, pressure, and volume of ink must be used.

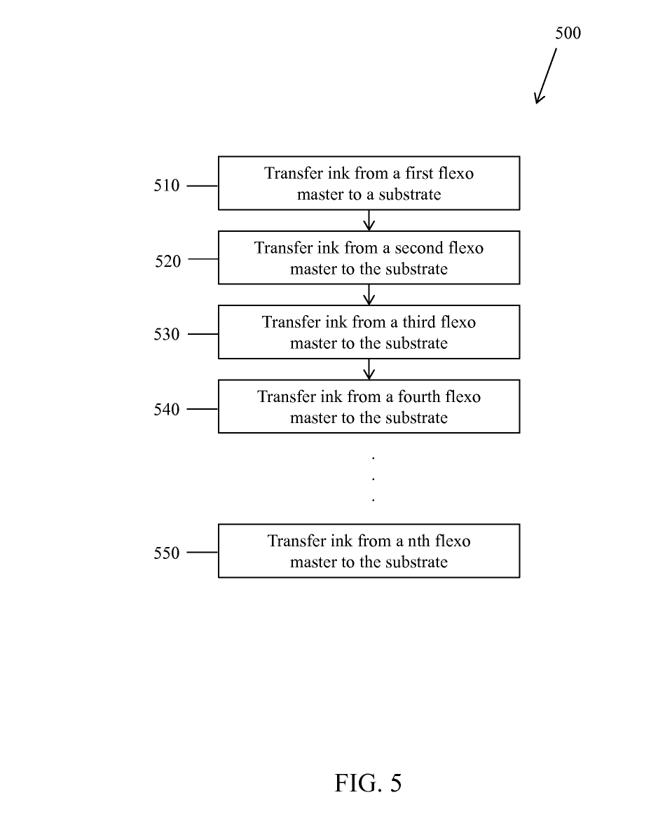

FIG. 5 shows a multi-station flexographic printing process 500 in accordance with one or more embodiments of the present invention. In one or more embodiments of the present invention, a multi-station flexographic printing process includes a sequence of flexographic printing processes. In one or more embodiments of the present invention, a multi-station flexographic printing process may be performed by multi-station flexographic printing system 400.

In step 510, ink may be transferred from a first flexo master of a first flexographic printing process to a substrate. The first flexo master includes an embossing pattern. In one or more embodiments of the present invention, the embossing pattern of the first flexo master includes lines of a first width or orientation. In one or more embodiments of the present invention, the embossing pattern of the first flexo master includes one or more x-axis printing lines. In one or more embodiments of the present invention, the one or more x-axis printing lines have a width of less than 10 microns. In one or more embodiments of the present invention, the one or more x-axis printing lines have a width in a range between approximately 10 microns and approximately 50 microns. In one or more embodiments of the present invention, the one or more x-axis printing lines have a width greater than 50 microns.

In step 520, ink may be transferred from a second flexo master of a second flexographic printing process to the substrate. The second flexo master includes an embossing pattern. In one or more embodiments of the present invention, the embossing pattern of the second flexo master includes lines of a second width or orientation. In one or more embodiments of the present invention, the embossing pattern of the second flexo master includes one or more y-axis printing lines. In one or more embodiments of the present invention, the one or more y-axis printing lines have a width of less than 10 microns. In one or more embodiments of the present invention, the one or more y-axis printing lines have a width in a range between approximately 10 microns and approximately 50 microns. In one or more embodiments of the present invention, the one or more y-axis printing lines have a width greater than 50 microns.

In step 530, ink may be transferred from a third flexo master of a third flexographic printing process to the substrate. The third flexo master includes an embossing pattern. In one or more embodiments of the present invention, the embossing pattern includes lines of a third width or orientation. In one or more embodiments of the present invention, the embossing pattern of the third flexo master includes one or more interconnect patterns. In one or more embodiments of the present invention, the one or more interconnect patterns have a width in a range between approximately 50 microns and approximately 100 microns.

In step 540, ink may be transferred from a fourth flexo master of a fourth flexographic printing process to the substrate. The fourth flexo master includes an embossing pattern. In one or more embodiments of the present invention, the embossing pattern includes lines of a fourth width or orientation. In one or more embodiments of the present invention, the embossing pattern of the fourth flexo master includes one or more connector patterns. In one or more embodiments of the present invention, the one or more connector patterns have a width greater than 100 microns.

In step 550, ink may be transferred from an nth flexo master of an nth flexographic printing process to the substrate. In one or more embodiments of the present invention, the multi-station flexographic printing process 500 may be extended to include transferring ink from a plurality of flexo masters to the substrate in sequence as the application demands. In one or more embodiments of the present invention, each flexo master comprises an embossing pattern having a different width or orientation.

One of ordinary skill in the art will recognize that the number of flexographic printing processes may be varied in accordance with one or more embodiments of the present invention. In one or more embodiments of the present invention, the flexographic printing processes are sequenced in order of increasing line or feature width. In one or more embodiments of the present invention, each flexographic printing process uses an independent flexo master. In one or more embodiments of the present invention, each independent flexo master includes an embossing pattern having a different width or orientation.

In one or more embodiments of the present invention, a different ink composition may be used for each flexo master. In one or more embodiments of the present invention, the ink compositions for each flexo master may be varied to achieve a desired fabrication of the substrate. In one or more embodiments of the present invention, each of the process parameters including target speed, composition, viscosity, pressure, and volume of ink may be varied for each flexo master.

Advantages of one or more embodiments of the present invention may include one or more of the following:

In one or more embodiments of the present invention, a multi-station flexographic printing system includes a plurality of flexographic printing stations, where each flexographic printing station includes an independent flexo master.

In one or more embodiments of the present invention, a multi-station flexographic printing system includes a plurality of flexographic printing stations, where each flexographic printing station transfers an ink image to the same substrate in sequence.

In one or more embodiments of the present invention, a multi-station flexographic printing system includes a plurality of flexographic printing stations that are sequenced in order of increasing width.

In one or more embodiments of the present invention, each independent flexo master includes an embossing pattern having a different width or orientation.

In one or more embodiments of the present invention, each independent flexo master includes an embossing pattern having a uniform width.

In one or more embodiments of the present invention, each independent flexo master includes an embossing pattern having a uniform height.

In one or more embodiments of the present invention, ink is more uniformly transferred from anilox roll to flexo master.

In one or more embodiments of the present invention, ink is more uniformly transferred from flexo master to substrate.

In one or more embodiments of the present invention, line width variations on substrate are minimized.

In one or more embodiments of the present invention, discontinuities of printed patterned lines on substrate are minimized.

In one or more embodiments of the present invention, a first flexographic printing station includes a first flexo master that includes an embossing pattern that comprises one or more x-axis printed lines.

In one or more embodiments of the present invention, a second flexographic printing station includes a second flexo master that includes an embossing pattern that comprises one or more y-axis printed lines.

In one or more embodiments of the present invention, a third flexographic printing station includes a third flexo master that includes an embossing pattern that comprises one or more interconnect patterns.

In one or more embodiments of the present invention, a fourth flexographic printing station includes a fourth flexo master that includes an embossing pattern that comprises one or more connector patterns.

In one or more embodiments of the present invention, a multi-station flexographic printing system includes a plurality of flexographic printing stations sequenced to print x-axis or y-axis printed lines first followed by interconnect patterns and then connector patterns.

In one or more embodiments of the present invention, because each station uses an independent flexo master, process parameters may be varied for each line width, feature, or orientation.

In one or more embodiments of the present invention, x-axis printed lines, y-axis printed lines, interconnect patterns, and connector patterns comprise a touch sensor.

In one or more embodiments of the present invention, a multi-station flexographic printing process may allow for the fabrication of improved touch sensors.

In one or more embodiments of the present invention, a multi-station flexographic printing process may allow for the fabrication of touch sensors with improved precision.

In one or more embodiments of the present invention, a multi-station flexographic printing process may allow for the fabrication of touch sensors with improved reliability.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A multi-station flexographic printing method comprising:
transferring an ink from a first flexo master to a substrate, wherein the first flexo master comprises an embossing pattern comprising lines of a first width or orientation;
transferring an ink from a second flexo master to the substrate, wherein the second flexo master comprises an embossing pattern comprising lines of a second width or orientation;
transferring an ink from a third flexo master to the substrate, wherein the third flexo master comprises an embossing pattern comprising lines of a third width or orientation; and
transferring an ink from a fourth flexo master to the substrate, wherein the fourth flexo master comprises an embossing pattern comprising lines of a fourth width or orientation.

2. The method of claim 1, wherein the embossing pattern of the first flexo master comprises one or more x-axis printing lines.

3. The method of claim 2, wherein the one or more x-axis printing lines have a width of less than 10 microns.

4. The method of claim 2, wherein the one or more x-axis printing lines have a width in a range between approximately 10 microns and approximately 50 microns.

5. The method of claim 1, wherein the embossing pattern of the second flexo master comprises one or more y-axis printing lines.

6. The method of claim 5, wherein the one or more y-axis printing lines have a width of less than 10 microns.

7. The method of claim 5, wherein the one or more y-axis printing lines have a width in a range between approximately 10 microns and approximately 50 microns.

8. The method of claim 1, wherein the embossing pattern of the third flexo master comprises one or more interconnect patterns.

9. The method of claim 8, wherein the one or more interconnect patterns have a width in a range between approximately 50 microns and approximately 100 microns.

10. The method of claim 1, wherein the embossing pattern of the fourth flexo master comprises one or more connector patterns.

11. The method of claim 10, wherein the one or more connector patterns have a width greater than 100 microns.

12. The method of claim 1, wherein the transfers of ink from each flexo master to the substrate are sequenced in an order of increasing embossing pattern width.

13. The method of claim 1, wherein a different ink composition may be used for each flexo master transfer.

14. A multi-station flexographic printing method comprising:
transferring an ink from a plurality of flexo masters to a substrate in sequence,
wherein each flexo master comprises an embossing pattern having a different width or orientation.

15. The method of claim 14, wherein at least one of the embossing patterns comprises one or more x-axis printing lines.

16. The method of claim 15, wherein the one or more x-axis printing lines have a width of less than 10 microns.

17. The method of claim 15, wherein the one or more x-axis printing lines have a width in a range between approximately 10 microns and approximately 50 microns.

18. The method of claim 14, wherein at least one of the embossing patterns comprises one or more y-axis printing lines.

19. The method of claim 18, wherein the one or more y-axis printing lines have a width of less than 10 microns.

20. The method of claim 18, wherein the one or more y-axis printing lines have a width in a range between approximately 10 microns and approximately 50 microns.

21. The method of claim 14, wherein at least one of the embossing patterns comprises one or more interconnect patterns.

22. The method of claim 21, wherein the one or more interconnect patterns have a width in a range between approximately 50 microns and approximately 100 microns.

23. The method of claim 14, wherein at least one of the embossing patterns comprises one or more connector patterns.

24. The method of claim 23, wherein the one or more connector patterns have a width greater than 100 microns.

25. The method of claim 14, wherein the transfers of ink from each flexo master to the substrate are sequenced in an order of increasing embossing pattern width.

26. The method of claim 14, wherein a different ink composition may be used for each flexo master transfer.

27. A multi-station flexographic printing system comprising:
a plurality of flexographic printing stations, wherein each flexographic printing station comprises:
an ink roll;
an anilox roll;
a plate cylinder;
a flexo master disposed on the plate cylinder; and
an impression cylinder,
wherein each flexo master comprises an embossing pattern having a different line width or orientation.

28. The system of claim 27, wherein an embossing pattern of a first flexo master of a first flexographic printing station comprises one or more x-axis printing lines.

29. The system of claim 28, wherein the one or more x-axis printing lines have a width of less than 10 microns.

30. The system of claim 28, wherein the one or more x-axis printing lines have a width in a range between approximately 10 microns and approximately 50 microns.

31. The system of claim 27, wherein an embossing pattern of a second flexo master of a second flexographic printing station comprises one or more y-axis printing lines.

32. The system of claim 31, wherein the one or more y-axis printing lines have a width of less than 10 microns.

33. The system of claim 31, wherein the one or more y-axis printing lines have a width in a range between approximately 10 microns and approximately 50 microns.

34. The system of claim 27, wherein an embossing pattern of a third flexo master of a third flexographic printing station comprises one or more interconnect patterns.

35. The system of claim 34, wherein the one or more interconnect patterns have a width in a range between approximately 50 microns and approximately 100 microns.

36. The system of claim 27, wherein an embossing pattern of a fourth flexo master of a fourth flexographic printing station comprises one or more connector patterns.

37. The system of claim 36, wherein the one or more connector patterns have a width greater than 100 microns.

38. The system of claim 27, wherein the plurality of flexographic printing stations are sequenced in an order of increasing embossing pattern width.

39. The method of claim 27, wherein a different ink composition may be used for each flexo master.
